(19) United States
(12) Patent Application Publication
(10) Pub. No.: US 2016/0042766 A1
(43) Pub. Date: Feb. 11, 2016

(54) CUSTOM VIDEO CONTENT

(71) Applicant: EchoStar Technologies L.L.C., Englewood, CO (US)

(72) Inventor: David Kummer, Highlands Ranch, CO (US)

(73) Assignee: EchoStar Technologies L.L.C.

(21) Appl. No.: 14/453,343

(22) Filed: Aug. 6, 2014

(51) Int. Cl. G11B 27/036; G10L 21/02; G10L 21/10; G06F 17/28

(52) U.S. Cl. CPC G11B 27/036; G06F 17/28; G10L 21/0202; G10L 21/10; G10L 2021/105

(57) ABSTRACT

Characteristics of speech in a first audio portion of media content in a first language are retrieved, the first audio portion being related to a video portion of the media content. A second audio portion is stored related to the video portion, the second audio portion including speech in a second language. Characteristics of the speech are used to modify the second audio portion

### BACKGROUND

When media content, e.g., a motion picture or the like (sometimes referred to as a “film”) is released to a country using a language other than a language used in making the media content, in many cases, audio dubbing is performed to replace a soundtrack in a first language with a soundtrack in a second language. For example, when a film from the United States is released in a foreign country, such as France, the English audio track may be removed and replaced with audio in the appropriate foreign language, e.g., French. Such dubbing is generally done by having actors who are native speakers of the foreign language provide voices of film characters in the foreign language. Often, attempts are made to provide translations of individual lines or words in a film soundtrack that are around the same length as the original, e.g., English, version, so that actor's mouths do not continue to move after a line is delivered, or stop moving while the line is still being delivered.

Unfortunately, dubbed voices are often dissimilar from those of original actors, e.g., inflections and styles of foreign language actors providing dubbed voices may not be realistic and/or may differ from those of the original actor. Further, because actors' lip movements made to form words of an original language may not match lip movements made to form words of a target language, the fact that a film has been dubbed may be obvious and distracting to a viewer. The alternative to dubbing that is sometimes used, sub-titles, suffers from the deficiency of distracting from the presentation of the media content, and causing user strain. Accordingly, other solutions are needed.

### DRAWINGS

FIG. 1 is a block diagram of an example system for processing media data that includes dubbed audio.

FIG. 2 is a flow diagram of an example process for generating a replacement media data for original media data where the replacement media data includes dubbed audio.

FIG. 3 illustrates an exemplary user interface for indicating and/or modifying an area of interest in a portion of a video.

### DETAILED DESCRIPTION

### Overview

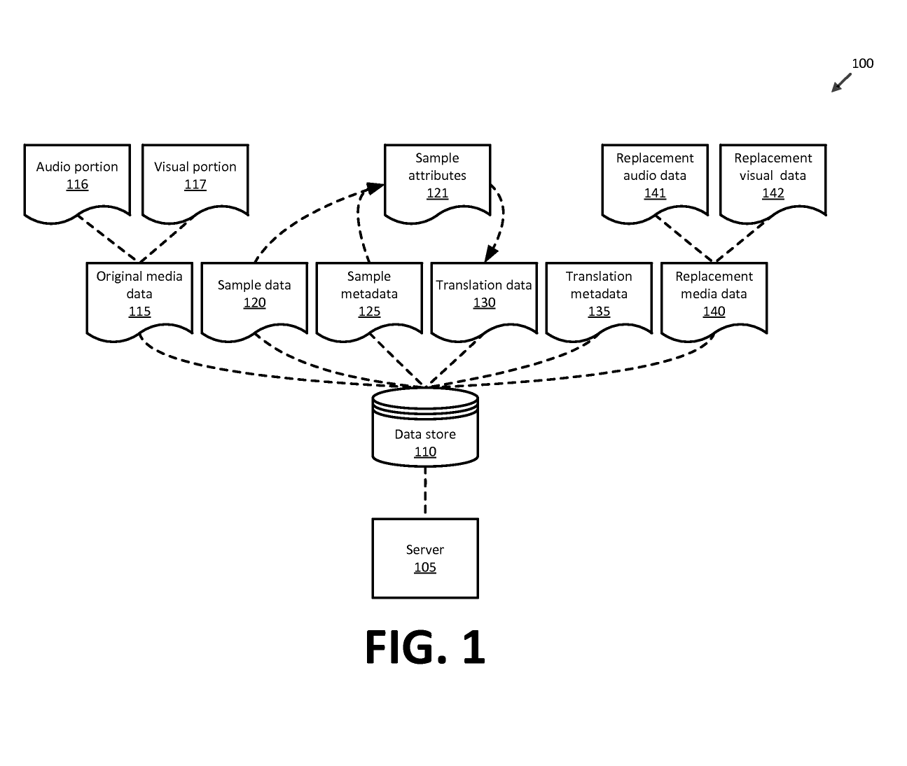

FIG. 1 is block diagram of a system 100 that includes a media server 105 programmed for processing media data 115 that may be stored in a data store 110. For example, the media data 115 may include media content such as a motion picture (sometimes referred to as a “film” even though the media data 115 is in a digital format), a television program, or virtually any other recorded media content. The media data 115 may be referred to as “original” media data 115 because it is provided with an audio portion 116 in a first or “original” language, as well as a visual portion 117. As disclosed herein, the server 105 is generally programmed to generate a set of replacement media data 140 that includes replacement audio data 141 in a second or “replacement” language. As further disclosed herein, replacement visual data 142 may be included in the replacement media data 140, where the visual data 142 modifies the original visual data 117 to better conform to the replacement audio data 141, e.g., such that actors' lip movements better reflect the replacement language, than the original visual data 117.

Accordingly, the server 105 is generally programmed to receive sample data 120 representing a voice or voices of an actor or actors included in the original media data 115. Sample metadata 125 is generally provided with the sample data 120. The metadata 125 generally indicates a location in the media data 115 with which the sample data 120 is associated. The server 105 is further generally programmed to receive translation data 130, which typically includes a translation of a script, transcript, etc., of an audio portion 116 of the original media data 115, along with translation metadata 135 specifying locations of the original media data 115 to which various translation data 130 apply.

Using the sample data 120 and translation data 130 according to the metadata 125 and 135, the server 105 is further generally programmed to generate the replacement audio data 141. Further, replacement visual data 142 may be generated according to operator input, e.g., specifying a portion of original visual data 117, e.g., a portion of a frame or frames representing an actor's lips, to be modified. Together, the audio data 141 and visual data 142 form the replacement media data 140, which provides a superior and more realistic viewing experience than was heretofore possible for dubbed media programs.

### Exemplary System Elements

The server 105 may include one or more computer servers, each generally including at least one processor and at least one memory, the memory storing instructions executable by the processor, including instructions for carrying out various of the steps and processes described herein. The server 105 may include or be communicatively coupled to a data store 110 for storing media data 115 and/or other data, including data 120, 125, 130, 135, and/or 140 as discussed herein.

Media data 115 generally includes an audio portion 116 and a visual, e.g., video, portion 117. The media data 115 is generally provided in a digital format, e.g., as compressed audio and/or video data. The media data 115 generally includes, according to such digital format, metadata providing various descriptions, indices, etc., for the media data 115 content. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media data 115 may be provided in a format such as the MPEG-1, MPEG-2 or the H.264/MPEG-4 Advanced Video Coding standards (AVC) (H.264 and MPEG-4 at present being consistent), or according to some other standard or standards.

For example, media data 115 could include, as an audio portion 116, audio data formatted according to standards such as MPEG-2 Audio Layer III (MP3), Advanced Audio Coding (AAC), etc. Also, as mentioned above, media data 115 generally includes a visual portion 117, e.g., units of encoded and/or compressed video data, e.g., frames of an MPEG file or stream. Further, the foregoing standards generally provide for including metadata, as mentioned above. Thus media data 115 includes data by which a display, playback, representation, etc. of the media data 115 may be presented.

Media data 115 metadata may include metadata as provided by an encoding standard such as an MPEG standard. Alternatively and/or additionally, media metadata 125 could be stored and/or provided separately, e.g., distinct from media data 115. In general, media data 115 metadata 125 provides general descriptive information for an item of media data 115. Examples of media data 115 metadata include information such as a film's title, chapter, actor information, Motion Picture Association of America MPAA rating information, reviews, and other information that describes an item of media data 115. Further, data 115 metadata may include indices, e.g., time and/or frame indices, to locations in the data 115. Moreover, such indices can be associated with other metadata, e.g., descriptions of an audio portion 116 associated with an index, e.g., characterizing an actor's emotions, tone, volume, speed of speech, etc., in speaking lines at the index. For example, an attribute of an actor's voice, e.g., a volume, a tone inflection (e.g., rising, lowering, high, low), etc., could be indicated by a start index and an end index associated with the attribute, along with a descriptor for the attribute.

Sample data 120 includes digital audio data, e.g., according to one of the standards mentioned above such as MP3, AAC, etc. Sample data 120 is generally created by a participant featured in original media data 115, e.g., a film actor or the like, providing samples of the participant's speech. For example, when a film is made in a first (sometimes called the “original”) language, and is to be dubbed in a second language, a participant may provide sample data 120 including examples of the participant speaking certain words in the second language. The server 105 is then programmed to analyze the sample data 120 to determine one or more sample attributes 121, e.g., the participant's manner of speaking, e.g., tone, pronunciation, etc., for words in the second, or target, language. Further, the server 105 may use sample metadata 125, which specifies an index or indices in original media data 115 for a given sample data or data 120.

Translation data 130 may include textual data representing a translation of a script or transcript of the audio portion 116 of original media data 115 from an original language into a second, or target language. Further, the translation data 130 may include an audio file, e.g., MP3, AAC, etc., generated based on the textual translation of the audio portion 116. For example, an audio file for translation data 130 may be generated from the textual data using known text-to-speech mechanisms.

Moreover, translation metadata 135 may be provided along with textual translation data 130, identifying indices or the like in the media data 115 at which a word, line, and/or lines of text are located. Accordingly, the translation metadata 135 may then be associated with audio translation data 130, i.e., may be provided as metadata for the audio translation data 130 indicating a location or locations with respect to the original media data 115 for which the audio translation data 130 is provided.

Replacement media data 140, like original media data 115, is a digital media file such as an MPEG file. The server 105 may be programmed to generate replacement audio data 141 included in the replacement media data 140 by applying sample data 120, in particular, sample attributes 121 determined from the sample data 120, to translation data 130. For example, sample data 120 may be analyzed in the server 105 to determine characteristics or attributes of a voice of an actor or other participant in an original media data 115 file, as mentioned above.

Such characteristics or attributes 121 may include the participant's accent, i.e., pronunciation, with respect to various phonemes in a target language, as well as the participant's tone, volume, etc. Further, as mentioned above, metadata accompanying original media data 115 may indicate a volume, tone, etc. with which a word, line, etc. was delivered in an original language of the media data 115. For example, metadata could include tags or the like indicating attributes 121 relating to how speech is delivered, e.g., “excited,” “softly,” “slowly,” etc. Alternatively or additionally, the server 105 could be programmed to analyze a speech file in a first language for attributes 121, e.g., volume of speech, speed or speech, inflections, tones, etc., e.g., using known techniques currently used in speech recognition systems or the like. In any case, the server 105 may be programmed to apply standard characteristics of a participant's speaking, as well as speech characteristics or attributes 121 with which a word, line, lines, etc. were delivered, to modify audio translation data 130 generate replacement audio data 141.

Replacement visual data 142 generally includes a set of MPEG frames or the like. Via a graphical user interface (GUI) or the like provided by the server 105, input may be received from an operator concerning modifications to be made to a portion or all of selected frames of the visual portion 117 of original media data 115. For example, an operator may listen to replacement audio data 141 corresponding to a portion of the visual portion 117, and determine that a participant's, e.g., an actor's, movements, e.g., mouth or lip movements, appear awkward, unconnected to, out of sync, etc., with respect to the audio data 141. Such lack of visual connection between lip movements in an original visual portion 117 and replacement audio data 141 may occur because lip movements for a first language are generally unrelated to lip movements forming translated words and a second language. Accordingly, an operator may manipulate a portion of an image, e.g., relating to an actor's mouth, face, or lips, so that the image does not appear out of sync with, or disconnected to, audio data 141.

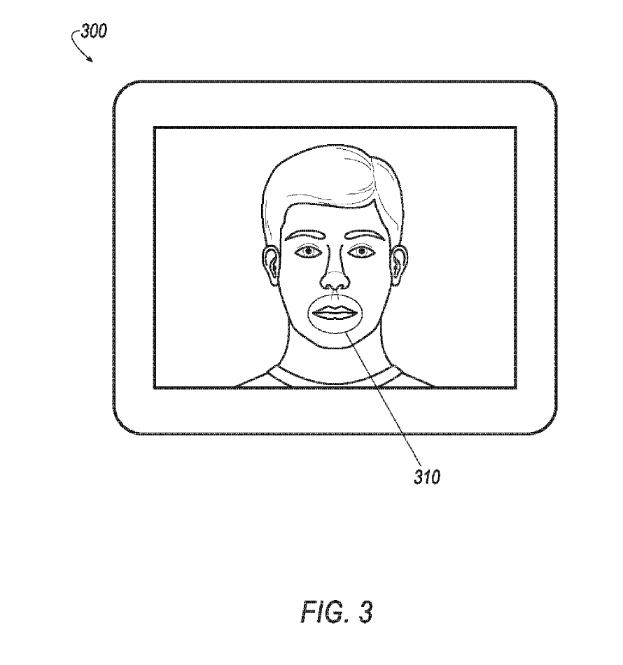

FIG. 3 illustrates an exemplary user interface 300 showing a video frame including an area of interest 310. For example, an operator may manipulate a portion of an image in the area of interest 310 so that an actor's mouth is moving in an expected way based on words in a target language being uttered by the actor's character according to audio data 141. For example, the server 105 could be programmed to allow a user to move a cursor using a pointing device such as a mouse, e.g., in a process similar to positioning a cursor with respect to a redeye portion of an image for redeye reduction, to thereby indicate a mouth portion or other feature in an area of interest 310 of an image to be smoothed or otherwise have its shape changed, etc.

### Exemplary Processing

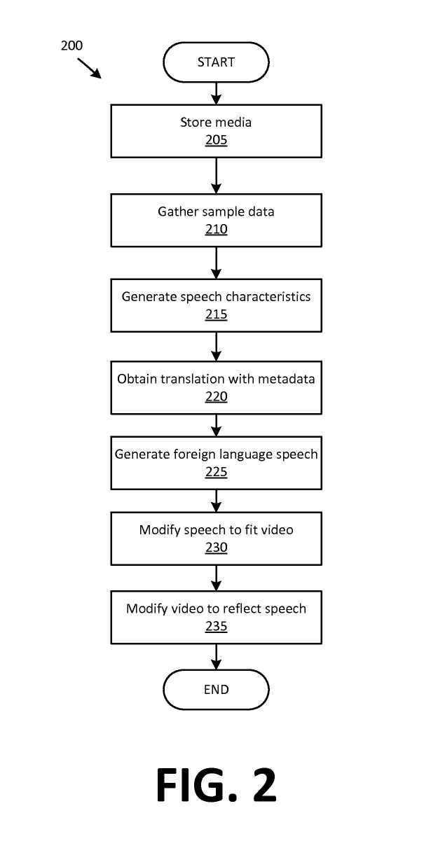

FIG. 2 is a flow diagram of an example process 200 for generating replacement media data 140 for original media data 115 where the replacement media data 140 includes dubbed audio data 141. The process 200 begins in a block 205, in which the server 105 stores media data 115, e.g., in the data store 110. For example, a file or files of a film, television program, etc., may be provided as the media data 115.

Next, in a block 210, the server 105 receives sample data 120. For example, the server 105 could include instructions for displaying a word or words in a target language to be spoken by an actor or the like, e.g., an actor in the original recording, i.e., including the original language, of media content included in the media data 115. The actor or other media data 115 participant could then speak the requested word or words which may then be captured by an input device, e.g., a microphone, of the server 105. Further, the media data participant 115, or in many cases, another operator, could indicate a location or locations in the media data 115 relevant to the sample data 120 being captured, thereby creating sample metadata 125.

Next, in a block 215, the server 105 generates sample data 120 attributes 121 such as described above. Attributes 121 are described above, e.g., could include speech accent, tone, pitch, fundamental frequency, rhythm, stress, syllable weight, loudness, intonation, etc. Further, it may be possible that using some of the words in the speech of a speaker such as an actor, the server 105 could generate a model of a speaker's vocal system to be used as a set of attributes 121.

Next, in a block 220, the server 105 retrieves, e.g., from the data store 110, the translation data 130 and translation metadata 135 related to the original data 115 stored in the block 205.

Next, in a block 225, the server 105 generates replacement audio data 141 to be included in replacement media data 145. For example, using the sample data 120 attributes 121, along with metadata from the original data 115, the translation data 130 and translation metadata 135, the server 105 may identify certain words or sets of words in audio data 130 according to indices or the like in translation metadata 135. The server 105 may then modify the identified words or sets of words according to sample data 120 attributes 121 for an actor or other participant in the media data 115. For example, a volume, speed, inflection, tone, etc., may be modified to substantially match, or approximate to the extent possible, such characteristics of a participant's voice in an original language.

Next, in a block 230, the replacement audio data 141 may be modified to better synchronize with a visual portion 142 of the replacement media data 140. Note that, although the visual portion 142 may not be generated until the block 235, described below, time indices for the visual portion 142 generally match time indices of the visual portion 117 of the original media file 115. However, it is also possible that, as discussed below, time indices of the visual portion 142 may be modified with respect to time indices of the visual portion 117 of the original media file 115. In any case, media data 115 may indicate first and second time indices for a word or words to be spoken in a first language, whereas it may be determined according to metadata for the replacement media file 140 that the specified word or words begin at the first time index, but end at a third time index after the second time index, i.e., it may be determined that a word or words in a target language take too much time. Accordingly, audio translation data 130 may be revised to provide a more appropriately short rendering of a word or words in a second language from a first language. The replacement audio data 141 may then be modified according to sample data 120 attributes 121, original data 115, and revised translation data 130 along with translation metadata 135.

Next, in a block 235, the visual portion 142 of the replacement media data 140 may be generated by modifying the visual portion 117 of the original media data 115. For example, an operator may provide input specifying a location of an actor's mouth in a frame or frames of data 117 and/or an operator may provide input specifying indices at which an actor's mouth appears unconnected to, or unsynchronized with, words being spoken according to audio data 141. Alternatively or additionally, the server 105 could include instructions for using pattern recognition techniques to identify a location of an actor's face, mouth, etc. The server 105 may further be programmed for modifying a shape and/or movement of an actor's mouth and/or face to better conform to spoken words in the data 141.

Following the block 235, the process 200 ends. However, note that certain steps of the process 200, in addition to being performed in a different order than set forth above, could also be repeated. For example, adjustments could be made to audio data 141 is discussed with respect to the block 230, visual data 142 could be modified as discussed with respect to the block 235, and then these steps could be repeated one or more times to fine-tune or better improve a presentation of media data 140.

### CONCLUSION

Computing devices such as those discussed herein such as the server 105 generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A method, comprising:
retrieving characteristics of speech in a first audio portion of media content in a first language, the first audio portion being related to a video portion of the media content;
storing a second audio portion related to the video portion, the second audio portion including speech in a second language; and
using characteristics of the speech to modify the second audio portion.

2. The method of claim 1, further comprising:
obtaining samples of a participant in the first audio portion; and
using the samples to identify at least one of the characteristics.

3. The method of claim 1, wherein the characteristics include at least one of a tone, a volume, a speed, and an inflection of the speech.

4. The method of claim 1, further comprising using metadata in the media content to identify at least one of the characteristics.

5. The method of claim 1, further comprising using metadata in the translation data to identify at least one of the characteristics.

6. The method of claim 1, further comprising using a timing of the speech to modify the second audio portion.

7. The method of claim 1, further comprising modifying at least some of the video portion based on the second audio portion, thereby generating a second video portion.

8. The method of claim 7, wherein the second video portion includes modifications to an appearance of lips of a participant in the media content.

9. The method of claim 1, further comprising modifying some of the second audio portion based on the video portion.

10. The method of claim 9, wherein modifying the second audio portion includes adjusting a length of time for a portion of the speech to be spoken.

11. A system, comprising a computer server programmed to:
retrieve characteristics of speech in a first audio portion of media content in a first language, the first audio portion being related to a video portion of the media content;
store a second audio portion related to the video portion, the second audio portion including speech in a second language; and
use characteristics of the speech to modify the second audio portion.

12. The system of claim 11, wherein the computer is further programmed to:
obtain samples of a participant in the first audio portion; and
use the samples to identify at least one of the characteristics.

13. The system of claim 11, wherein the characteristics include at least one of a tone, a volume, a speed, and an inflection of the speech.

14. The system of claim 11, wherein the computer is further programmed to use metadata in the media content to identify at least one of the characteristics.

15. The system of claim 11, wherein the computer is further programmed to use metadata in the translation data to identify at least one of the characteristics.

16. The system of claim 11, wherein the computer is further programmed to use a timing of the speech to modify the second audio portion.

17. The system of claim 11, wherein the computer is further programmed to modify at least some of the video portion based on the second audio portion, thereby generating a second video portion.

18. The system of claim 17, wherein the second video portion includes modifications to an appearance of lips of a participant in the media content.

19. The system of claim 11, wherein the computer is further programmed to modify some of the second audio portion based on the video portion.

20. The system of claim 19, wherein modifying the second audio portion includes adjusting a length of time for a portion of the speech to be spoken.
